(19) United States
(12) Patent Application Publication
(10) Pub. No.: US 2010/0017539 A1
(43) Pub. Date: Jan. 21, 2010

(54) METHOD AND DEVICE FOR THE EXCHANGE OF DATA

(75) Inventors: Jürgen Heiles, München (DE); Matthias Schnitter, München (DE)

Correspondence Address: LERNER GREENBERG STEMER LLP, P O BOX 2480, HOLLYWOOD, FL, 33022-2480, US

(73) Assignee: NOKIA SIEMENS NETWORKS GMBH & CO. KG, Munchen (DE)

(21) Appl. No.: 12/515,387

(22) PCT Filed: Nov. 20, 2007
(86) PCT No.: PCT/EP2007/010006

§ 371 Date: May 18, 2009

(30) Foreign Application Priority Data
Nov. 24, 2006 (DE) 10 2006 055 959.2

(51) Int. Cl. G06F 15/173

(52) U.S. Cl. 709/249

(57) ABSTRACT

A method and devices for the exchange of data between a client network access system and a provider network access system. A message is sent from the provider network access system to the client network access system. The message triggers a response containing information about the client network access system, the response being sent from the client network access system to the provider network access system. The message uses a multicast address in a destination MAC address field, which functions in such a way that messages addressed thereto are not forwarded by the client network access system, and the information relates to an Ethernet OAM function. If the message is an inquiry, for example, as to whether the Ethernet OAM function is supported by the client network access system, the provider network access system can automatically be adapted to the configuration of the client network access system.

The present invention relates to methods and devices for the exchange of data between a client network access system and a provider network access system.

In a broadband access network, for example with digital subscriber line (DSL) or passive optical network (PON) technologies for the subscriber access, the network operator is interested in monitoring the connection from a provider network access system up to a client network access system.

A provider network access system has the primary task of providing for a connection to a client network access system.

The provider network access system is typically a device which can be connected directly to the client network access system via Layer 2 of the OSI model. The provider network access system can be, for example, a network node (especially a Layer 2 network node), a broadband network gateway (BNG), an IP edge router, a broadband remote access server (BRAS), a multiplexer, especially a digital subscriber line access multiplexer (DSLAM), or a combination thereof. The provider network access system is normally accommodated in the premises of a network operator.

The client network access system has the primary task of providing for a connection to a provider network access system. It is normally accommodated at a customer and in most cases also in his property. It is primarily used for connecting electronic devices or electronic assemblies of the customer to the access network of the provider. The term “client network access system” therefore especially covers the terms “network terminating device”, “modem”, “switch”, “bridge” and “router”.

Tasks which are to be solved by the monitoring of the provider are, for example determining whether the connection is operating and, in the case of complaints by the customer finding, eliminating or preventatively counteracting certain faults. In some broadband access networks, asynchronous transfer mode (ATM) is used as Layer 2 protocol in order to establish an end-to-end connection from the BNG to the network terminating device. To provide for the required monitoring, ATM supports corresponding operation, administration and maintenance (OAM) functions which enable the end-to-end connection to be monitored. OAM functions for ATM (ATM OAM) are disclosed, for example, in ITU-T standard 1.610.

ATM is traditionally used as a Layer 2 protocol where Ethernet can then be transmitted via ATM. This means that Ethernet frames are segmented at the transmitter, packed into ATM cells and transmitted and are unpacked from the ATM cells at the receiver and assembled together to form Ethernet frames. In modern broadband networks, however, ATM is increasingly replaced by Ethernet or, respectively, new broadband access networks based on Ethernet are installed. Ethernet is then transmitted directly via Layer 1. This means that Ethernet frames are transmitted directly by means of the technology of the physical layer (e.g. DSL). There is no additional encapsulation into ATM cells. In the case where Ethernet is used on Layer 2, an end-to-end monitoring of the connection should still be possible. For this purpose, OAM functions for Ethernet (Ethernet OAM) have already been defined, for example in ITU-T Standard Y.1731 and IEEE Draft Standard 802.1ag. These provide for end-to-end monitoring on the Ethernet MAC layer (Layer 2).

In order to be able to use standardized Ethernet OAM functions, however, they need to be implemented in the client network access system and in the provider network access system. Whilst the network operator has full control over the provider network access system and can equip the latter correspondingly with OAM functions, the client network access system is normally in possession of the customer and can therefore not be easily exchanged and/or configured for Ethernet OAM. For this reason, there is a need to adapt the interface of a provider network access system to which a client network access system is connected to the configuration of the client network access system. For this purpose, the provider network access system must have knowledge about any support of Ethernet OAM provided by the client network access system.

From the Liaison Statement of ITU-T Q.5/13 to the DSL Forum of 24 Feb. 2006 “Reply Liaison Statement on Ethernet OAM functionality”, a method is known in which the provider network access system attempts to obtain knowledge about the support of Ethernet OAM by the client network access system by sending a multicast Ethernet Loopback Message (ETH-LBM) frame to the client network access system and evaluating the response of the client network access system. If the client network access system sends back an Ethernet Loopback Reply (ETH-LBR) frame, it obviously supports Ethernet OAM. If no ETH-LBR frame arrives within a certain time, Ethernet OAM is obviously not supported. The disadvantageous factor in this method is, however, that the ETH-LBR frame can also originate from another device located in the network of the customer instead of from the client network access device which possibly does not support Ethernet OAM. In this case, the provider network access system would obtain misleading information and draw from this a wrong conclusion. It is also possible that the special Layer-2 connection which is to be monitored with Ethernet OAM is faulty. In this case, it is also possible that the ETH-LBM and/or the ETH-LBR frames are not transmitted via the connection. Although the client network access system possibly supports Ethernet OAM, the provider network access system falsely assumes that it does not support the latter.

The present invention is based on the object of exchanging data between a client network access system and a provider network access system.

This object is achieved by the features specified in the independent claims. Advantageous embodiments of the invention are specified in further claims.

In this context, a message is sent from the provider network access system to the client network access system. The message uses in its destination MAC address field a multicast address which is not forwarded by the client network access system.

This means that a frame which is sent to this address is not forwarded by the client network access system. On the basis of the message, the client network access system sends a response which relates to an Ethernet OAM function. In a preferred embodiment, it can be found out in this manner whether the Ethernet OAM function is supported by the client network access system.

It is advantageous in this solution that, by using the multicast address which is not forwarded, the message of the provider network access system cannot be forwarded beyond the client network access system into the network of the customer. This ensures that devices in the network of the customer which are behind the client network access system cannot respond to the message with a response to the provider network access system and thus the provider network access system cannot draw a wrong conclusion with respect to the client network access system. In addition, the solution can be used with Ethernet OAM implementations according to ITU-T Standard Y.1731 and according to IEEE Draft Standard 802.1ag. It is also not necessary that the provider network access system knows the MAC address of the client network access system before sending the message because the message does not use a unicast MAC address but a multicast MAC address. Furthermore, the message and the response can still be transmitted even if the special Layer-2 connection to be monitored is faulty.

MAC addresses which are not forwarded by the client network access system are, for example, Slow Protocol Multicast Addresses (Annex 43B from IEEE Standard 802.3-2005) or Group MAC addresses (Table 7.10 and Chapter 7.12.6 from IEEE Standard 802.1D-2004).

Normally, a maximum of ten frames per second are sent for a Slow Protocol. However, several Slow Protocols can also run in parallel when the rate of frames per unit time is greater. In addition, frames of a Slow Protocol are untagged, i.e. the frames do not run in a VLAN. A Slow Protocol normally uses the value (Ethertype) “88-09” in the Length/Type Field of the Ethernet frame. The receiver recognizes from this value that the frame belongs to a Slow Protocol.

In an advantageous embodiment, the information contained in the response states whether an Ethernet OAM function is supported by the client network access system or not. If, for example, the client network access system is newly connected to an interface of the provider network access system, the provider network access system is informed in this way that the Ethernet OAM function is supported. As a consequence, the provider network access system can configure the interface for the Ethernet OAM function.

Since the response uses the source MAC address of the message in its destination MAC address field, the response can be transmitted directly to the provider network access system. As an alternative, the response, in order to be transmitted to the provider network access system, can also use in its destination MAC address field a multicast address which is not forwarded by the provider network access system.

By determining a Layer-2 protocol, which is used by the client network access system, preferably before sending the message or before sending the response, it is already possible to draw conclusions with respect to any support of Ethernet OAM by the client network access system. If, for example, the client network access system only supports ATM via the Layer 1, it can be concluded that Ethernet OAM is not supported by the client network access system.

By checking whether an Ethernet protocol is supported by the client network access system on Layer 2, especially whether Ethernet via ATM and/or whether Ethernet via Layer 1 is supported, it is possible to conclude that the possibility exists that Ethernet OAM is supported by the client network access system and that therefore a check whether Ethernet OAM is supported is appropriate.

In a preferred embodiment, the response contains information about several Ethernet OAM functions which are supported by the client network access system. In an especially preferred embodiment, the response contains information about all Ethernet OAM functions which are supported by the client network access system.

The response can be divided into several part-responses. For example, each part-response can contain a value “true” or “false”, the values specifying whether a particular Ethernet OAM function is supported by the client network access system.

Examples of Ethernet OAM functions are the Loopback protocol, the Linktrace protocol and the Continuity Check protocol, which are defined in ITU-T Y.1731 and IEEE 802.1ag. Other examples which are defined in ITU-T Y.1731 are the Ethernet Alarm Indication Signal protocol, the Ethernet Remote Defect Indication protocol, the Ethernet Locked Signal protocol, the Ethernet Test Signal protocol, the Ethernet Automatic Protection Switching protocol, the Ethernet Maintenance Communication Channel protocol, the Ethernet Experimental OAM protocol, the Ethernet Vendor Specific OAM protocol, the Frame Loss Measurement protocol, the Frame Delay Measurement protocol and the Throughput Measurement protocol.

According to a further aspect of the invention, a provider network access system is proposed which comprises means which are adapted to carrying out a method according to the invention.

In the text which follows, the invention will be explained in greater detail by way of example referring to the drawing, in which:

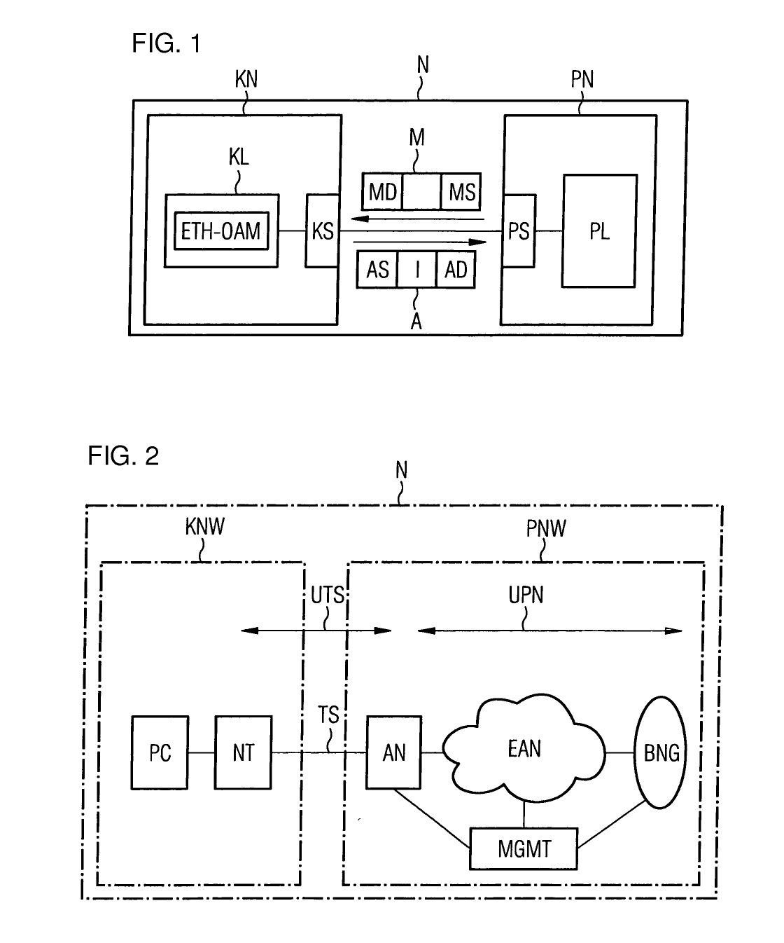

FIG. 1 shows a network which comprises a provider network access system and a client network access system in one embodiment of the invention;

FIG. 2 shows a network in a further embodiment;

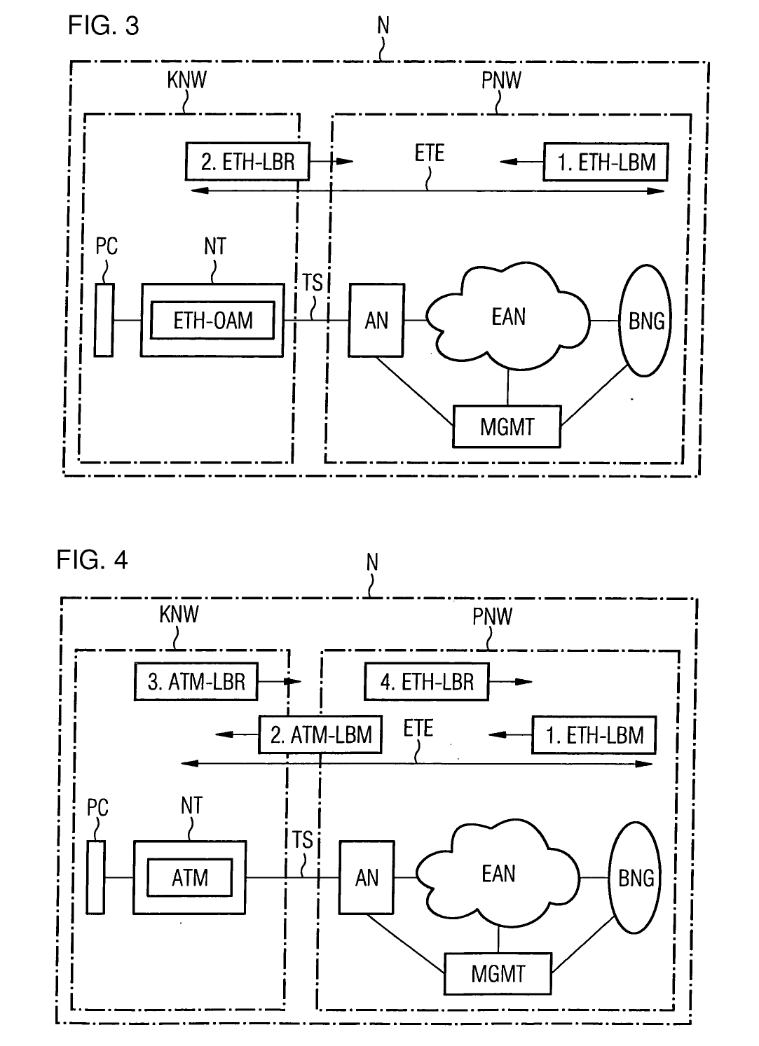

FIG. 3 shows a network in a further embodiment;

FIG. 4 shows a network in a further embodiment; and

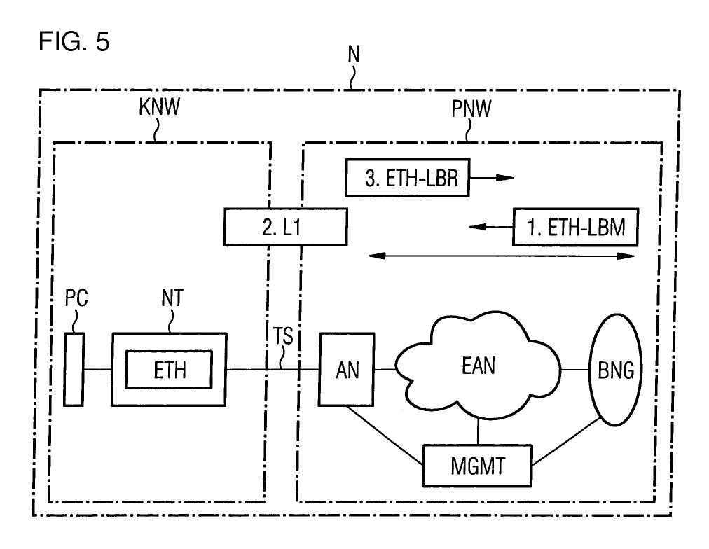

FIG. 5 shows a network in a further embodiment.

FIG. 1 shows a network N which comprises a provider network access system PN and a client network access system KN. The client network access system KN comprises a client logic KL and a client interface KS. The client logic KL has an Ethernet OAM function ETH OAM. The provider network access system PN comprises a provider logic PL and a provider interface PS. To carry out a method according to a preferred embodiment of the invention, a message M is sent from the provider network access system PN to the client network access system KN. The message M uses in a destination MAC address field a multicast address MD which is not forwarded by the client network access system KN. On the basis of the message M, the client network access system KN generates a response A which comprises information about the client network access system KN, and sends it to the provider network access system PN.

The message M preferably uses in a source MAC address field MS the MAC address of the provider network access system which is inserted into the destination MAC address field AD of the response A by the client network access system. The source MAC address field AS of the response preferably comprises the MAC address of the client network access system KM.

In an especially preferred embodiment, the response A comprises the information that the client network access system has implemented the Ethernet OAM function. This information is especially useful if the client network access system has been connected to the provider network access system PN immediately before the sending of the message because the provider network access system PN can be informed by this means that the provider interface PS to which the client network access system KN has been connected should be configured for the Ethernet OAM function.

In a further especially preferred embodiment, the message M comprises a write command and at least one value for a parameter which is adjusted in the client network access system KN. In this case, the response A contains a confirmation that the parameter has been adjusted. The written parameters can also be optionally supplied together with the response A.

In a further especially preferred embodiment, the message M comprises a read command. This is useful, for example, if the provider network access system must find out values of the parameters adjusted in the client network access system at the time. The parameters to be read are supplied together with the response.

FIG. 2 shows an embodiment of a network N which comprises a client network KNW and a provider network PNW. The provider network PNW comprises a broadband network gateway BNG and an access node AN which, for example, can be constructed as a DSL access multiplexer (DSLAM). In this embodiment, the access node AN assumes the function of the provider network access system PN. The broadband network gateway BNG and the access node AN are connected to one another via an Ethernet aggregation network EAN. The provider network PNW can contain further network nodes which, for example, are comprised by the Ethernet aggregation network EAN.

The client network KNW comprises a client network access system which is constructed as network terminating device NT. The client network KNW can contain further devices which are connected to the network terminating device NT and are symbolized here by a terminal, for example a personal computer PC.

The provider network PNW uses Ethernet as Layer-2 technology. It can therefore be monitored by means of Ethernet OAM functions. This monitoring is designated as monitoring of the provider network UPN in FIG. 2. This means that, for example, the BNG sends monitoring messages to the access node AN at regular intervals. From the arrival of a monitoring message, the access node AN can conclude that the data transmission from the broadband network gateway BNG to the access node AN is functioning. The monitoring messages are advantageously transmitted within the same logical Ethernet channels in which other data are also transmitted. This ensures that the monitoring messages are subject to the same possible fault conditions as the other data. If, for example, a data transmission is interrupted by a fault, the transmission of the monitoring messages is also interrupted.

The monitoring messages can also be transmitted in the opposite direction from the access node AN to the broadband network gateway BNG. By this means, for example, the operation of the data transmission from AN to BNG is checked. It is also possible to monitor only individual subsections in this manner, for example the section from the broadband network gateway BNG to a network node located in the Ethernet aggregation network EAN.

In the text which follows, the network section from the access node AN to the network terminating device NT is called the subscriber interface TS. The subscriber interface TS can only be checked with Ethernet OAM functions if the network terminating device NT supports Ethernet OAM. Since this is possibly not known to the operator, however, it is either necessary to carry out a detection of the Ethernet OAM functionality in the network terminating device NT or to dispense with Ethernet OAM and to monitor this section with other methods. Commonly used methods for monitoring the subscriber interface TS are, for example, the monitoring by means of “Ethernet in the first mile” EFM OAM according to IEEE Standard 802.3-2005 and monitoring Layer 1, dispensing with monitoring of Layer 2. Although it is possible to check in the monitoring of the subscriber interface TS by means of EFM OAM whether Ethernet frames can be transmitted at all between access node AN and network terminating device NT, the possibility is lacking to check the logical channels individually within Layer 2. If, as an alternative, only Layer 1 of the subscriber interface is monitored and monitoring of Layer 2 is dispensed with, it is only possible to monitor whether the transmission technology is operating, i.e. whether information can be transmitted at all. It is not possible to monitor whether messages of the Layer-2 protocol used can be transmitted.

For this reason, the access node AN has a means for sending a message via the subscriber interface to the network terminating device NT. The message uses in its destination MAC address field a special multicast address on the basis of which the immediately nearest layer-2 device receives, but does not forward, the message. An example of such a special multicast address is, for example, a Slow Protocol multicast address. The message also contains the request to send an answer which provides information as to whether the network terminating device NT has implemented Ethernet OAM, back to the access node AN. The message can be triggered autonomously by the access node or on command of a network management system MGMT. If the network terminating device NT has implemented Ethernet OAM, it will understand the request and send a confirmatory response. If it has not implemented the Ethernet OAM function, it will either understand the request and send a negative response or it will not understand the request and will not send a response. Using the special multicast address devices which are behind the network terminating device NT in the client network are prevented from sending a wrong response to the access node AN. As a result, the access node AN is able to reliably assess whether it can monitor the monitoring section UTS by means of Ethernet OAM up to the network terminating device NT. Such an automatic determination is useful, especially if the network terminating device NT is newly connected to the access node AN. For this purpose, it can be provided that the access node AN repeatedly sends the message to the special multicast address at predefined time intervals.

FIG. 3 shows a further embodiment which is based on the embodiment of FIG. 2 described above. In this embodiment, the network terminating device NT supports the Ethernet OAM function. The network terminating device NT will therefore send back to the access node AN the response that Ethernet OAM is supported.

As a consequence, the subscriber interface TS can be monitored by means of Ethernet OAM. All subsections between the network terminating device NT and the broadband network gateway BNG would therefore be monitored: between the network terminating device NT and the access node AN, on the one hand, and between the access node AN and the broadband network gateway BNG, on the other hand. However, a fault could now still occur within the access node AN which would not be recognized since one monitoring section would already be finished but the next one would not have begun yet.

In a further preferred embodiment, it is therefore desirable to introduce a genuine end-to-end monitoring ETE in which monitoring messages are sent from the BNG through all network nodes up to the NT and from the NT through all network nodes back to the BNG. This is possible, for example, by the network terminating device NT writing its own MAC address into the source MAC address field. As a consequence, this is forwarded, together with the information that the network terminating device NT has implemented the Ethernet OAM function, to the broadband network gateway BNG. Conversely, the broadband network gateway BNG can subsequently transmit its own MAC address with a message addressed to the network terminating device NT. This creates the prerequisites for monitoring messages to be selectively sent between the network terminating device NT and the broadband network gateway BNG as a result of which the complete path from the BNG to the NT can be monitored by means of Ethernet OAM functions. This monitoring is indicated by an Ethernet loopback message frame ETH-LBM which is sent from the BNG to the NT and which is answered with an Ethernet Loopback reply frame ETH-LBR from the NT to the BNG. The monitoring therefore represents an end-to-end monitoring ETE.

FIG. 4 shows a further embodiment which is based on the embodiment of FIG. 2 described above. The network terminating device NT is constructed for using Layer-2 technology on the subscriber interface ATM. This means that no Ethernet frames are packed in the ATM cells but the useful data are packed directly in ATM cells. Since the network terminating device NT supports ATM, it must be assumed that it also supports ATM OAM functions, but no Ethernet OAM functions. The network terminating device NT will therefore not send a response to the access node which confirms the support of Ethernet OAM. The network terminating device will typically send an error message back to the access node which is used by the latter as an indication that the network terminating device NT does not support any Ethernet OAM function. It must also be mentioned that the access node AN can determine already when the NT device is connected to the subscriber line and during the subsequent starting-up of Layer-1 technology that the network terminating device supports ATM. From this it is possible to conclude that the network terminating device NT also supports ATM OAM and the subscriber interface can therefore be monitored by means of ATM OAM functions.

Since, on the other hand, the Layer-2 technology in the provider network is Ethernet, the provider network can be monitored by means of Ethernet OAM functions. End-to-end monitoring only possible in a restricted way because the messages which are used by Ethernet OAM functions for monitoring the provider network must be translated in the AN into such messages as are used by the ATM OAM functions for monitoring. In this context, a part of the information can be lost. For example, the Ethernet loopback message frame ETH-LBM sent by the BNG to the AN is converted into one or more ATM loopback message cells ATM-LBM in the AN and sent to the NT. The NT responds to the incoming ATM loopback cell with a further ATM loopback reply cell ATM-LBR which it sends back to the access node AN. Following the reception of the ATM loopback reply cell ATM-LBR, the access node AN generates an Ethernet loopback reply frame ETH-LBR which it sends back to the BNG. From the received ETH-LBR frame, it is possible to conclude that the data transmission from the BNG up to the NT and from the NT up to the BNG is working.

FIG. 5 shows a further embodiment which is based on the embodiment of FIG. 2 described above. The network terminating device NT is constructed for using Ethernet as Layer-2 technology on the subscriber interface TS. In this context, the Ethernet frames are transmitted directly by the Layer-1 technology, i.e. they are not previously packed in ATM cells. The network terminating device NT does not support any Ethernet OAM functions. Although the network terminating device NT is using Ethernet as Layer-2 technology, but does not support any Ethernet OAM functions, the subscriber interface TS cannot be monitored by means of Ethernet OAM functions. The network terminating device NT informs the access node AN of this in the response. However, the possibility remains, for example, of dispensing with monitoring of the Layer 2 and monitoring only the Layer 1. Monitoring of the network N then proceeds, for example, in such a manner that the BNG sends an Ethernet loopback message frame ETH-LBM to the access node AN, the access node AN thereupon checks the Layer 1 on the subscriber interface in that it interrogates, for example, its status L1 with respect to layer 1, and the access node AN sends an Ethernet loopback reply frame ETH-LBR back to the BNG in the case where the Layer-1 test has supplied a positive result. In case of a negative test result, the access node AN does not send an ETH-LBR frame to the BNG.

FIG. 2 also shows a network management system MGMT of the provider network PNW. The network operator can control the provider network PNW by means of the network management system MGMT. For example, he can perform it to read out adjustments at the network elements in the provider network, for example at the access node AN or the broadband network gateway BNG, via the network management system MGMT.

In a special embodiment which is independent of the previously described embodiments, the network management system MGMT sends a request to the access node AN to send a message which contains a write or read command to the network terminating device NT. The request contains, for example, the information whether the message should contain a write command or a read command. In the case of a write command, the request additionally contains, for example, information about one or more parameters to be written and, for example, their values. In the case of a read command, the request contains additional information about one or more parameters to be read. The information which is contained in the response of the network terminating device NT, for example the read values of the parameter or parameters in the case of a read command and, for example, a confirmation in the case of a write command, is sent to the network management network MGMT from the access node AN.

The present invention is independent of what Layer-1 technology is used. For an access network, DSL (digital subscriber line) or PON (passive optical network) can be used at Layer 1, for example.

### LIST OF REFERENCE DESIGNATIONS USED

A Response
AD Destination MAC address field of the response
AN Access node
ATM-LBM ATM loopback message cell
ATM-LBR ATM loopback reply cell
AS Source MAC address field of the response
BNG Broadband network gateway
DSLAM DSL access multiplexer
EAN Ethernet aggregation network
ETH-LBM Ethernet loopback message frame
ETH-LBR Ethernet loopback reply frame
ETH OAM Ethernet OAM function
KL Client logic
KN Client network access system
KNW Client network
KS Client interface
L1 Layer-1 status of the subscriber interface
M Message
MD Destination MAC address field of the message
MGMT Network management system
MS Source MAC address field of the message
N Network
NT Network terminating device
AN Access node
PL Provider logic
PN Provider network access system
PNW Provider network
PS Provider interface
TS Subscriber interface

1-11. (canceled)

12: A method of exchanging data between a client network access system and a provider network access system, the method which comprises:
sending a message from the provider network access system to the client network access system;
the message using a multicast address in a destination MAC address field, functioning in such a way that a frame addressed to said multicast address is not forwarded by the client network access system, and the message contains a request for information related to an Ethernet OAM function;
triggering, with the message, a response from the client network access system to the provider network access system containing information about an Ethernet OAM functionality of the client network access system.

13: The method according to claim 12, wherein the information states whether or not the client network access system supports the Ethernet OAM function.

14: The method according to claim 12, which comprises using the source MAC address of the message in a destination MAC address field of the response.

15: The method according to claim 12, which comprises using in the response a destination MAC address field with a further multicast address or the same multicast address which is not forwarded by the provider network access system.

16: The method according to claim 15, wherein the multicast address and/or the further multicast address is a Slow Protocol multicast address according to Annex 43B from IEEE Standard 802.3-2005 or a Group MAC address according to table 7.10 and chapter 7.12.6 of IEEE Standard 802.1 D-2004.

17: The method according to claim 12, which comprises determining at least one Layer-2 protocol that is used by the client network access system.

18: The method according to claim 17, which comprises checking whether an Ethernet protocol is supported by the client network access system on Layer 2.

19: The method according to claim 17, which comprises checking whether Ethernet via ATM and/or whether Ethernet via Layer 1 is supported.

20: The method according to claim 12, wherein the response comprises information about several Ethernet OAM functions supported by the client network access system.

21: The method according to claim 20, wherein the response comprises information about all Ethernet OAM functions supported by the client network access system.

22: The method according to claim 12, wherein an interface of the provider network access system is configured for supporting the Ethernet OAM function or a selection of Ethernet OAM functions.

23: A provider network access system, comprising means configured for carrying out the method according to claim 12.

24: A network (N), comprising a provider network access system and a client network access system configured for carrying out the method according to claim 12.
